(19) United States
(12) Patent Application Publication
(10) Pub. No.: US 2006/0232160 A1
(43) Pub. Date: Oct. 19, 2006

(54) ARMATURE CORE, ARMATURE, METHOD FOR MANUFACTURING ARMATURE CORE, AND METHOD FOR MANUFACTURING ARMATURE

(75) Inventors: Kazunobu KANNO, Toyohashi-shi (JP); Kouichi NAKAMURA, Toyohashi-shi (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: ASMO CO., LTD., Kosai-shi (JP)

(21) Appl. No.: 11/279,783

(22) Filed: Apr. 14, 2006

(30) Foreign Application Priority Data
Apr. 14, 2005 (JP) 2005-117089

(51) Int. Cl. H02K 1/00

(52) U.S. Cl. 310/216

(57) ABSTRACT

An armature includes an armature core, a rotary shaft inserted into a shaft fixing hole of the armature core, and coils each wound about one of teeth of the armature core. The teeth extend radially. The armature core includes an inner core having the shaft fixing hole, and an outer core that is provided about and is integrated with the inner core. The inner core is formed by laminating a plurality of magnetic steel plates. The outer core is formed by compression molding magnetic powder, and includes the teeth. Accordingly, the armature core has a high mechanical strength and is capable of obtaining a high magnetic flux density. Also, the armature core is easy to manufacture.

### BACKGROUND OF THE INVENTION

The present invention relates to an armature core that is used in an inner rotor type rotating electric machine. The present invention also relates to an armature having such a core and methods for manufacturing such core and armature.

This type of armature core has at its center a shaft fixing hole for fixing a rotary shaft, and at peripheral portions a plurality of teeth about each of which a coil is wound. Conventionally, most of such armature cores are formed by laminating magnetic steel plates each having a shaft fixing hole and teeth. Since such a laminated type core has a high mechanical strength, a rotary shaft can be directly press fitted into the shaft fixing hole. However, the magnetic property of a laminated type core is determined by the property of the laminated steel plates, the density of the magnetic flux cannot be increased beyond a certain level.

Other than laminated type cores, armature cores formed by compression molding magnetic powder (for example, see Japanese Laid-Open Patent Publication No. 2003-333780) haven been proposed. Such armature cores are called powder cores. Due to recent developments of magnetic powder materials, powder cores can be made to have a higher magnetism than laminated type cores.

A powder core has a lower mechanical strength than a laminated type core. Therefore, when attaching a rotary shaft to a powder core, the rotary shaft cannot be directly press fitted to the core. This is because when attempting to obtain a certain fixing strength between the core and the shaft, a relatively large press fit allowance is required for a powder core, and such a large press fit allowance can cause a crack in the powder core.

Accordingly, Japanese Laid-Open Patent Publication No. 2003-333780 discloses a cylindrical coupling member that is located between a powder core and a rotary shaft. The coupling member is press fitted to the powder core, and the rotary shaft is press fitted to the coupling member. In this case, since the coupling member contacts the powder core in a large area, the required press fit allowance is reduced. This prevents the powder core from being cracked while maintaining a certain level of fixing strength.

However, according to the above publication, the powder core is molded first, and then the coupling member is press fitted to the molded powder core. Subsequently, the rotary shaft is press fitted to the coupling member. The method has a considerable number of steps and factors of cost increase.

### SUMMARY OF THE INVENTION

Accordingly, it is an objective of the present invention to provide an armature core that has a high mechanical strength, is capable of obtaining a high magnetic flux density, and is easy to manufacture. Other objectives of the present invention are to provide an armature having the core and to provide a method for manufacturing the core and the armature.

To achieve the foregoing objective, a first aspect of the present invention provides an armature core including an inner core and an outer core. The inner core has a shaft fixing hole that permits insertion of a rotary shaft. The inner core is formed by laminating a plurality of magnetic steel plates. The outer core is provided about and integrated with the inner core and is formed by compression molding magnetic powder. The outer core includes a plurality of teeth extending radially, each tooth permitting a coil to be wound thereabout.

A second aspect of the present invention provides an armature including the above armature core, a rotary shaft, and a plurality of coils. The rotary shaft is inserted into the shaft fixing hole of the armature core. The coils are each wound about one of the teeth of the armature core.

A third aspect of the present invention provides a method for manufacturing the above armature core. The method includes: forming an inner core by laminating a plurality of magnetic steel plates; placing the inner core in a molding tool and filling the interior of the molding tool with magnetic powder; and compression molding the magnetic powder in the molding tool, thereby forming an outer core such that the outer core integrated with the inner core.

A fourth aspect of the present invention provides a method for manufacturing an armature. The armature includes the above armature core, a rotary shaft, and a plurality of coils. The rotary shaft is inserted into the shaft fixing hole of the armature core. The coils are each wound about one of the teeth of the armature core. The method includes: forming an inner core by laminating a plurality of magnetic steel plates; placing the inner core in a molding tool and filling the interior of the molding tool with magnetic powder; compression molding the magnetic powder in the molding tool, thereby forming an outer core such that the outer core integrated with the inner core; inserting a rotary shaft into the shaft fixing hole of the armature core; and winding coils about each tooth of the armature core.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a plan view illustrating an armature according to a first embodiment of the present invention;

FIG. 1B is a cross-sectional view taken along line 1B-1B of FIG. 1A;

FIGS. 2A, 2B, and 2C are cross-sectional views illustrating a molding tool for explaining a manufacturing method of the core incorporated in the armature of FIG. 1A;

FIG. 3A is a plan view illustrating a core according to a second embodiment of the present invention;

FIG. 3B is a cross-sectional view illustrating a first core piece (second core piece) of the core shown in FIG. 3A; and

FIG. 3C is a bottom view illustrating the core of FIG. 3A.

### DETAILED DESCRIPTION OF THE PREFERRED EMBODIMENTS

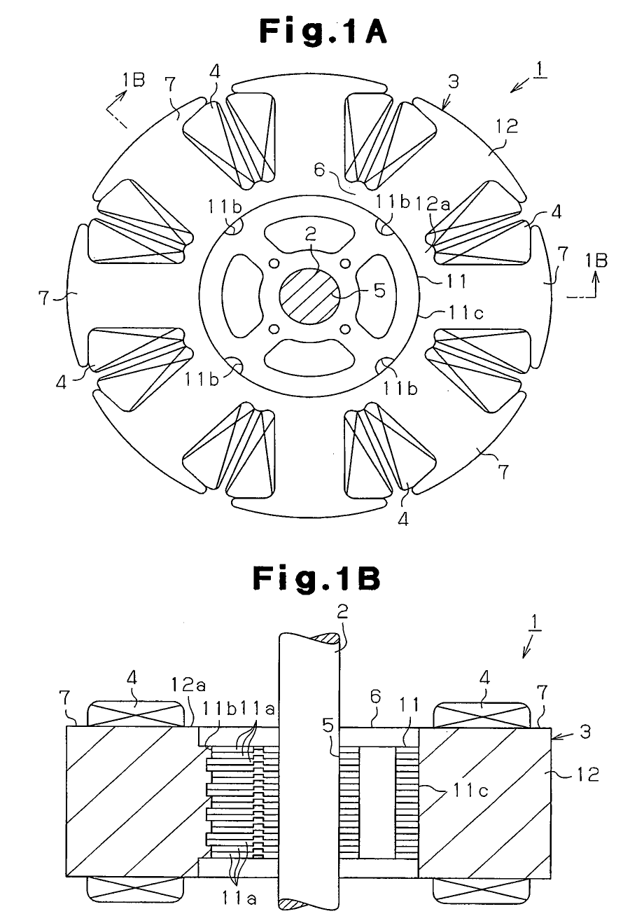

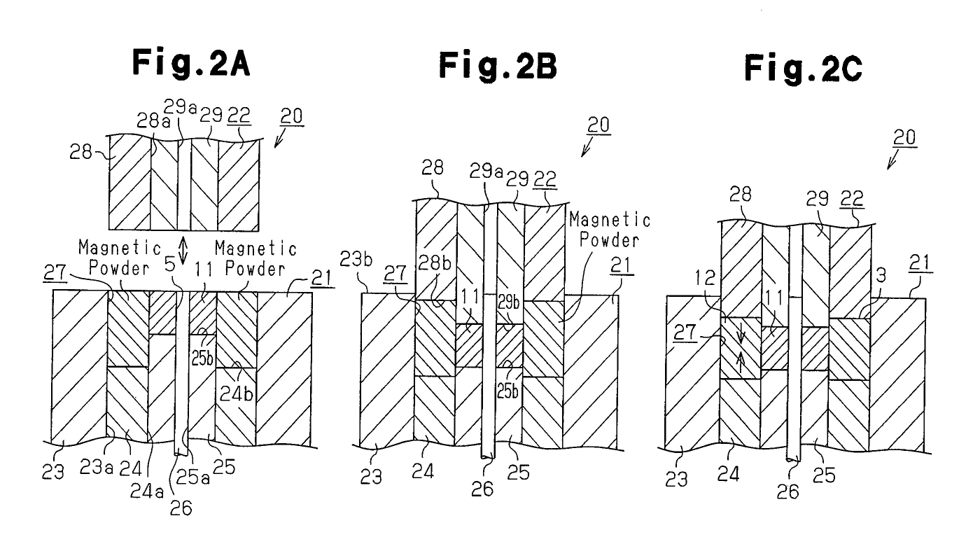

A first embodiment of the present invention will now be described with reference to FIGS. 1A to 2C.

FIGS. 1A and 1B show an armature 1 according to the first embodiment used in a rotating electric machine. The armature 1 is rotatably supported inside of an annular stator (not shown), and rotates when receiving a magnetic field generated by the stator. The armature 1 includes a columnar rotary shaft 2, a core 3 to which the rotary shaft 2 is attached, and coils 4 wound about the core 3. The core 3 rotates integrally with the rotary shaft 2.

The core 3 includes a substantially columnar core body 6 and teeth 7, the number of which is eight in this embodiment. The core body 6 has a shaft fixing hole 5 having a circular cross-section. The shaft fixing hole 5 receives the rotary shaft 2. The teeth 7 extend radially from the outer circumference of the core body 6. Each coil 4 is wound about one of the teeth 7. The core 3 is formed by an inner core 11 and an outer core 12, which are made of different materials.

The inner core 11 is substantially shaped as a column having a slightly less diameter than that of the core body 6, and has at its center the shaft fixing hole 5. As shown in FIG. 1B, the inner core 11 is formed by laminating along an axial direction of the inner core 11 identically shaped magnetic steel plates 11a. Four engagement portions, which are engagement recesses 11b in this embodiment, are formed on the outer circumferential surface of the inner core 11 to correspond to alternate ones of the teeth 7 (in this embodiment, at intervals of 90°). The engagement recesses 11b are formed inward with respect to the radial direction and semicircular as viewed from top.

The outer core 12 has an annular portion 12a and the teeth 7. The annular portion 12a corresponds to a portion of the core body 6 except for the inner core 11 and is located immediately outside of the inner core 11. The teeth 7 radially project from the outer circumference of the annular portion 12a. The annular portion 12a has sections that enter the engagement recesses 11b of the inner core 11, which firmly secures the outer core 12 and the inner core 11 to each other. The teeth 7 are arranged at equal angular intervals about the axis of the inner core 11 (at intervals of 45°). The proximal end of each tooth 7 is coupled to the annular portion 12a. The outer core 12 is formed by compression molding magnetic powder, and integrated with the inner core 11. That is, the entire core 3 is completed when the outer core 12 is molded, so that the manufacturing process is simplified.

The outer circumferential surface of the inner core 11 is a coupling surface 11c coupled to the outer core 12. Since the inner core 11 is formed by laminating the magnetic steel plates 11a, the coupling surface 11c is uneven due to dimension errors and assembly errors of the magnetic steel plates 11a. Since the asperities of the coupling surface 11c are significantly small, the coupling surface 11c is illustrated as flat in FIG. 1B. Since the inner circumference of the outer core 12 digs into the coupling surface 11c, the outer core 12 is engaged with the inner core 11. That is, the coupling surface 11c firmly couples the outer core 12 to the inner core 11. Asperities as the engagement recesses 11b may be positively formed on the coupling surface 11c. The coupling surface 11c and the engagement recesses 11b firmly couple the inner core 11 and the outer core 12 to each other with respect to the circumferential direction and the axial direction of the inner core 11.

The manufacturing process of the core 3 will now be described with reference FIGS. 2A, 2B, and 2C.

A molding tool 20 for molding the outer core 12 includes a lower mold 21 and an upper mold 22, which contacts and separates from the lower mold 21. The lower mold 21 has a die 23 having an insertion hole 23a at its center. The insertion hole 23a has a circular cross-section. A cylindrical outer knockout 24 is slidably inserted into the insertion hole 23a of the die 23. An insertion hole 24a is formed inside of the outer knockout 24. An inner knockout 25 is slidably inserted in the insertion hole 24a.

An insertion hole 25a is formed inside of the inner knockout 25. A columnar rod 26 is located in the insertion hole 25a such that the upper end of the rod 26 is at the same height as the upper end of the die 23. The rod 26 is inserted in the shaft fixing hole 5 of the inner core 11 to support the inner core 11. In the lower mold 21, the outer knockout 24 and the inner knockout 25 slide between the die 23 and the rod 26.

FIG. 2A shows the molding tool 20 in an initial step of the manufacturing process for the core 3. In the initial step, an upper surface 25b of the inner knockout 25 is lower than the upper end of the rod 26. Specifically, the upper surface 25b of the inner knockout 25 is lower than the upper end of the rod 26 by the amount corresponding to the axial length of the inner core 11 placed on the upper surface 25b. An upper surface 24b of the outer knockout 24 is lower than the upper surface 25b of the inner knockout 25 and is lower than the upper end of the rod 26 by the amount corresponding to the amount of filling magnetic powder. Accordingly, the upper surface 24b of the outer knockout 24, the inner circumferential surface of the die 23, the outer circumferential surface of the inner knockout 25, and the outer circumferential surface of the inner core 11, which is placed on the upper surface 25b of the inner knockout 25 define a molding recess 27, which is filled with magnetic powder.

On the other hand, the upper mold 22 has an outer punch 28 and an inner punch 29. The outer punch 28 is cylindrical and has the same inner and outer diameters as the outer knockout 24. The outer punch 28 is arranged to face the outer knockout 24. The outer punch 28 is slidable toward the outer knockout 24. An insertion hole 28a is formed inside the outer punch 28. The cylindrical inner punch 29, which has the same inner and outer diameters as the inner knockout 25, is located in the insertion hole 28a to face the inner knockout 25 (to face the placed inner core 11). The inner punch 29 is slidable toward the inner knockout 25. An insertion hole 29a is formed inside the inner punch 29 to receive the rod 26. In the initial step shown in FIG. 2A, the upper mold 22 is separated from the lower mold 21.

Using the above described molding tool 20 for molding the outer core 12, the inner core 11, which has been produced through a process for laminating the magnetic steel plates 11a, is placed on the upper surface 25b of the inner knockout 25 of the lower mold 21 by inserting the rod 26 into the shaft fixing hole 5 of the inner core 11. Next, the molding recess 27 defined in the lower mold 21 is filled with magnetic powder for forming the outer core 12.

Subsequently, the upper mold 22 is slid down until it contacts the lower mold 21. Thereafter, the inner punch 29 is lowered so that the rod 26 is inserted into the insertion hole 29a of the inner punch 29 as shown in FIG. 2B. A lower surface 29b of the inner punch 29 contacts the inner core 11. The inner punch 29 presses the inner knockout 25 downward with the inner core 11. Accordingly, the inner punch 29 moves the inner core 11 to a predetermined position. As the inner punch 29 moves downward, the outer punch 28 moves downward. The outer punch 28 is lowered to a position at which its lower surface 28b is slightly lower than an upper surface 23b of the die 23. In this state, the outer punch 28 applies a small pressing force to the magnetic powder in the molding recess 27 and closes the molding recess 27.

Then, as shown in FIG. 2C, the outer punch 28 is further moved downward so that the outer punch 28 and the outer knockout 24 approach each other. Accordingly, the magnetic powder in the molding recess 27 is compressed with a predetermined pressure, so that the outer core 12 is molded. Simultaneously, the outer core 12 is integrally formed with the inner core 11. Thereafter, the upper mold 22 is separated from the lower mold 21, and the complete core 3 is removed.

The rotary shaft 2 is press fitted to the shaft fixing hole 5 of the inner core 11, so that the core 3 is secured to the rotary shaft 2. Since the inner core 11, to which the rotary shaft 2 is press fitted, is formed by laminating the steel plates 11a, the inner core 11 has a sufficiently high mechanical strength to bear the direct insertion of the rotary shaft 2.

The coils 4 are wound about each tooth 7 of the outer core 12. A drive current is supplied to the coils 4, so that magnetic flux is generated in each tooth 7 at predetermined timing. Accordingly, a magnetic field to rotate the core 3 is produced. Being made of the magnetic powder, each tooth 7 of the outer core 12 has an increased density of magnetic flux, and thus has an enhanced magnetic efficiency. As a result, the drive efficiency of the rotating electric machine is improved.

The first embodiment has the following advantages.

The inner core 11 is formed by laminating the magnetic steel plates 11a and has the shaft fixing hole 5. The outer core 12 has the teeth 7 and the annular portion 12a surrounding the outer circumference of the inner core 11. The outer core 12 is formed by compression molding the magnetic powder, and integrated with the inner core 11. Since the teeth 7 are made of the magnetic powder, the density of the magnetic flux generated in each tooth 7 is increased. The shaft fixing hole 5, to which the rotary shaft 2 is fixed, is formed in the inner core 11, which is formed by laminating the steel plates 11a. Therefore, the portion surrounding the shaft fixing hole 5 has a sufficient mechanical strength that bears the press fitting of the rotary shaft 2 into the shaft fixing hole 5. This permits the rotary shaft 2 to be directly press fitted to the shaft fixing hole 5. This improves the magnetic efficiency of the armature 1. Further, when molded, the outer core 12 is integrated with the inner core 11 to form the core 3. This simplifies the manufacturing process of the core 3 and the manufacturing process of the armature 1.

Since the outer core 12 is integrally molded with the inner core 11, for example, compared to a case where an inner core is attached (press fitted) to an outer core, the dimensional accuracy of the outer core 12 does not need to be enhanced to prevent cracking of the outer core 12. Also, the accuracy of the position of the outer core 12 relative to the inner core 11 is improved.

The outer core 12 is configured to include the entire teeth 7. That is, the entire teeth 7 are formed of the magnetic powder. Therefore, the density of the magnetic flux generated in the teeth 7 is efficiently increased, and the magnetic efficiency is further increased.

The outer core 12 has the annular portion 12a coupled to the proximal ends of the teeth 7. That is, the teeth 7 are connected to one another by the annular portion 12a made of the magnetic powder. This increases the density of magnetic flux that passes through the magnetic circuit formed by each tooth 7 and the annular portion 12a. This further increases the magnetic efficiency. Also, the structure allows the teeth 7 to be firmly coupled to the core body 6.

The annular portion 12a extends to surround the inner core 11, and is easily formed together with the teeth 7 by compression molding the magnetic powder.

The inner core 11 has the engagement recesses 11b that is engaged with the molded outer core 12. That is, since the engagement recesses 11b of the inner core 11 are engaged with the outer core 12, the inner core 11 and the outer core 12 are firmly coupled to each other.

Since the inner core 11 is formed by laminating the magnetic steel plates 11a, the outer circumferential surface of the inner core 11, which is the coupling surface 11c coupled to the outer core 12 is uneven due to dimension errors and assembly errors of the steel plates 11a. Therefore, the coupling surface 11c digs into the inner circumference of the outer core 12. This firmly couples the inner core 11 and the outer core 12 to each other.

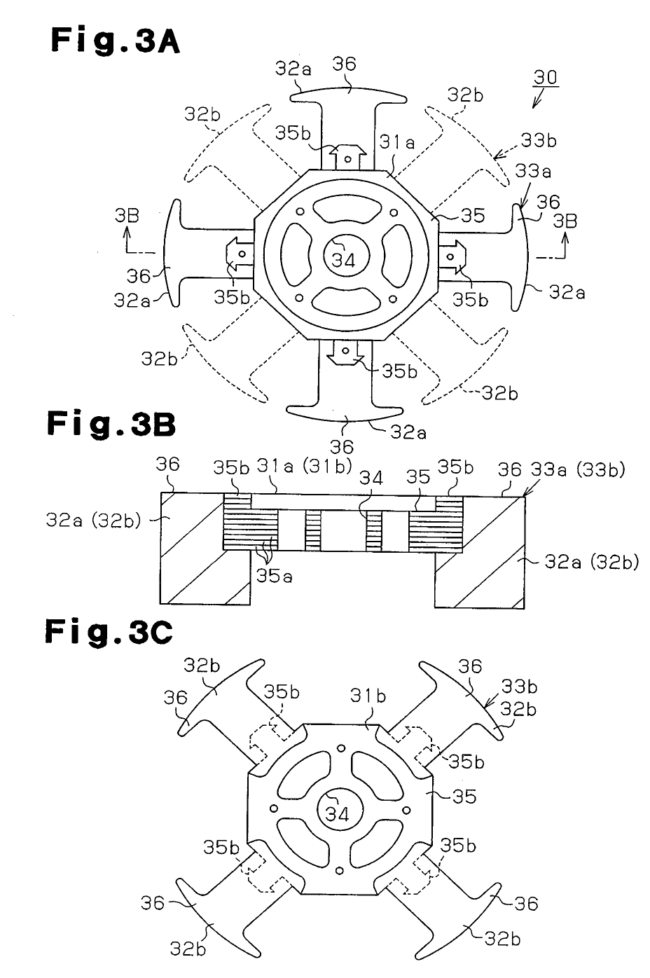

A second embodiment of the present invention will now be described with reference to FIGS. 3A to 3C.

As shown in FIGS. 3A, 3B, and 3C, a core 30 according to the second embodiment includes a first core piece 33a and a second core piece 33b. The first core piece 33a includes a regular octagonal prism like first core body 31a and four first teeth 32a provided in the circumference of the first core body 31a. The second core piece 33b includes a regular octagonal prism like second core body 31b and four second teeth 32b provided in the circumference of the second core body 31b. The first core piece 33a and the second core piece 33b have an identical shape in this embodiment. The first core piece 33a and the second core piece 33b are coaxially combined to each other such that the first teeth 32a of the first core piece 33a and the second teeth 32b of the second core piece 33b are alternately arranged in the circumferential direction of the core 30.

Each of the first and second core pieces 33a, 33b is formed of an inner core 35 and an outer core 36. The inner core 35 is formed by laminating magnetic steel plates 35a along the axial direction. The outer core 36 is formed by compression molding magnetic powder. The inner core 35 forms the entirety of one of the first core body 31a and the second core body 31b. The outer core 36 forms one of the set of the first teeth 32a and the set of the second teeth 32b.

The inner core 35 has a shaft fixing hole 34 at a center. Four engagement portions, which are engagement projections 35b projecting radially outward in this embodiment, are formed on the outer circumferential surface of the inner core 35 to correspond to the teeth 32a, 32b (in this embodiment, at intervals of 90° about the axis of the inner core 35). The width of each engagement projection 35b widens at a position near the distal end, and then gradually decreases toward the distal end. The axial length of the inner core 35 is half the axial length of the core 30 (see FIG. 3B).

The outer core 36 (the first and second teeth 32a, 32b) projects radially outward from the outer circumference of the inner core 35 to cover the engagement projections 35b. The first and second teeth 32a, 32b are engaged with the engagement projections 35b so as to be firmly coupled to the inner core 35. The first and second teeth 32a, 32b are formed along the entire axial direction of the inner core 35, and protrude on one side of the axial direction of the inner core 35. As in the first embodiment, the outer core 36 is formed by compression molding magnetic powder, and integrated with the inner core 35. That is, the entire first and second core pieces 33a, 33b are complete when the outer core 36 is molded, so that the manufacturing process is simplified.

A method for manufacturing the core 30 will now be described. To manufacture the core 30, a molding tool (not shown) is used. First, the magnetic steel plates 35a are laminated to form the inner core 35. Then, the inner core 35 is located in the molding tool, and the molding tool is filled with magnetic powder. Then, the magnetic powder is compression molded. As a result, the outer core 36 is formed such that the outer core 36 integrated with the inner core 35. The first and second core pieces 33a, 33b are thus completed. Thereafter, the first core piece 33a and the second core piece 33b are assembled to form the core 30. A rotary shaft (not shown) is press fitted to the shaft fixing hole 34 of the inner core 35 of the completed core 30. A coil (not shown) is wound about each tooth 32a, 32b of the outer core 36, and an armature of this embodiment is produced.

The second embodiment provides the following advantages.

As in the first embodiment, since the teeth 32a, 32b are formed of magnetic powder, the density of the magnetic flux generated in each of the teeth 32a, 32b is increased in the second embodiment. The shaft fixing hole 34, to which the rotary shaft is fixed, is formed in the inner core 35, which is formed by laminating the steel plates 35a. Therefore, the portion surrounding the shaft fixing hole 34 has a sufficient mechanical strength that bears the press fitting of the rotary shaft into the shaft fixing hole 34. This permits the rotary shaft to be directly press fitted to the shaft fixing hole 34. This improves the magnetic efficiency of the armature. Further, when molded, the outer core 36 is integrated with the inner core 35 to form the core 30. This simplifies the manufacturing process of the core 3 and the manufacturing process of the armature. Particularly, since the core 30 includes two components, or the first core piece 33a and the second core piece 33b, in this embodiment, the advantage is remarkable.

The inner core 35 has the engagement projections 35b that is engaged with the molded outer core 36. This firmly couples the inner core 35 with the outer core 36. In addition, as in the first embodiment, the inner core 35 is formed by laminating the magnetic steel plates 35a. Thus, the outer circumference surface of the inner core 35 is uneven and digs into the inner circumference of the outer core 36. This further firmly couples the inner core 35 and the outer core 36 to each other.

The above embodiments of the present invention may be modified as follows.

In the first embodiment, the rotary shaft 2 is attached to the inner core 11 after molding the outer core 12. However, the rotary shaft 2 may be attached to the inner core 11 before molding the outer core 12. That is, with the rotary shaft 2 attached thereto, the inner core 11 may be placed in the molding tool 20, and the outer core 12 may be molded in this state.

In the first embodiment, the inner core 11 has the engagement recesses 11b, and in the second embodiment, the inner core 35 has the engagement projections 35b. However, the inner core 11 may have engagement projections, and the inner core 35 may have engagement recesses. The engagement recesses 11b and the projections 35b may be replaced by holes. Further, if the inner core 11, 35 and the outer core 12, 36 are sufficiently firmly coupled to each other, the engagement recesses 11b and the engagement projections 35b may be omitted.

In the illustrated embodiments, the configurations of the inner cores 11, 35 formed by laminating the steel plates 11a, 35a, and the outer cores 12, 16 formed by molding powder may be changed as necessary. The structure of the inner cores 11, 35 may be changed as long as the inner core 11, 35 each include the shaft fixing hole 5, 34, and the structure of the outer core 12, 36 may be changed as long as the outer core 12, 36 include at least part of the teeth 7, 32a, 32b.

1. An armature core comprising:
an inner core having a shaft fixing hole that permits insertion of a rotary shaft, the inner core being formed by laminating a plurality of magnetic steel plates; and
an outer core being provided about and integrated with the inner core, the outer core being formed by compression molding magnetic powder, wherein the outer core includes a plurality of teeth extending radially, each tooth permitting a coil to be wound thereabout.

2. The armature core according to claim 1, wherein the teeth include all of entire teeth that the armature core has.

3. The armature core according to claim 2, wherein the outer core further includes an annular portion that is coupled to a proximal end of each tooth.

4. The armature core according to claim 3, wherein the annular portion extends to surround the inner core.

5. The armature core according to claim 1, wherein the inner core includes an engagement portion that is engaged with the outer core.

6. The armature core according to claim 1, wherein asperities are formed on an outer circumferential surface of the inner core, and wherein the outer core is integrated with the inner core such that the magnetic powder forming the outer core enters the asperities.

7. The armature core according to claim 1, wherein the armature core is formed by coaxially combining a first core piece and a second core piece, which are formed separately, the first core piece having some of the teeth, the second core piece having the rest of the teeth, and wherein, in the armature core, the teeth of the first core piece and the teeth of the second core piece are alternately arranged along a circumferential direction of the armature core.

8. An armature comprising:
the armature core according to claim 1;
a rotary shaft inserted into the shaft fixing hole of the armature core; and
a plurality of coils each wound about one of the teeth of the armature core.

9. A method for manufacturing the armature core according to claim 1, comprising:
forming an inner core by laminating a plurality of magnetic steel plates;
placing the inner core in a molding tool and filling the interior of the molding tool with magnetic powder; and
compression molding the magnetic powder in the molding tool, thereby forming an outer core such that the outer core integrated with the inner core.

10. A method for manufacturing the armature core according to claim 7, including:
separately forming a first core piece and a second core piece; and
coaxially combining the first core piece and the second core piece, the forming of the first core piece and the forming of the second core piece each comprising:
forming an inner core by laminating a plurality of magnetic steel plates;
placing the inner core in a molding tool and filling the interior of the molding tool with magnetic powder; and
compression molding the magnetic powder in the molding tool, thereby forming an outer core such that the outer core integrated with the inner core.

11. A method for manufacturing an armature, the armature including:
the armature core according to claim 1;
a rotary shaft inserted into the shaft fixing hole of the armature core; and
a plurality of coils each wound about one of the teeth of the armature core, the method comprising:
forming an inner core by laminating a plurality of magnetic steel plates;
placing the inner core in a molding tool and filling the interior of the molding tool with magnetic powder;
compression molding the magnetic powder in the molding tool, thereby forming an outer core such that the outer core integrated with the inner core;
inserting a rotary shaft into the shaft fixing hole of the armature core; and
winding coils about each tooth of the armature core.

12. A method for manufacturing an armature, the armature including:
the armature core according to claim 7;
a rotary shaft inserted into the shaft fixing hole of the armature core; and
a plurality of coils each wound about one of the teeth of the armature core, the method including:
separately forming a first core piece and a second core piece;
coaxially combining the first core piece and the second core piece,
inserting a rotary shaft into the shaft fixing hole of the armature core; and
winding coils about each tooth of the armature core, the forming of the first core piece and the forming of the second core piece each comprising:
forming an inner core by laminating a plurality of magnetic steel plates;
placing the inner core in a molding tool and filling the interior of the molding tool with magnetic powder; and
compression molding the magnetic powder in the molding tool, thereby forming an outer core such that the outer core integrated with the inner core.
